(19) United States
(12) Patent Application Publication
(10) Pub. No.: US 2025/0313273 A1
(43) Pub. Date: Oct. 9, 2025

(54) FRONT SIDE BODY OF VEHICLE

(71) Applicants: Hyundai Motor Company, Seoul (KR); Kia Corporation, Seoul (KR)

(72) Inventors: Jong Gwan Yun, Busan (KR); Yong Dok An, Anyang-Si (KR); Do Hoi Kim, Sejong-Si (KR); Mun Soo Cha, Suwon-Si (KR)

(21) Appl. No.: 18/816,350

(22) Filed: Aug. 27, 2024

(30) Foreign Application Priority Data
Apr. 3, 2024 (KR) 10-2024-0045479

(51) Int. Cl. B62D 25/08

(52) U.S. Cl. CPC B62D 25/085; B62D 25/088

(57) ABSTRACT

A body of a vehicle may comprise a front side member comprising a crash box at a front end of the front side member, wherein the front side member is configured to extend in a longitudinal direction of the vehicle, a shock absorber housing disposed between the front end and a rear end of the front side member and connected to the front side member, and a pillar connected to the rear end of the front side member, wherein the front side member, the shock absorber housing, and the pillar are molded integrally with each other, and first horizontal ribs and first vertical ribs are formed to cross each other at the front end to create spaces, wherein the first horizontal ribs are parallel to the longitudinal direction of the vehicle, and wherein the first vertical ribs are vertical to the longitudinal direction of the vehicle.

### CROSS REFERENCE TO RELATED APPLICATIONS

The present application claims priority to Korean Patent Application No. 10-2024-0045479, filed Apr. 3, 2024, the entire contents of which is incorporated herein for all purposes by this reference.

### TECHNICAL FIELD

The present disclosure relates to a front side body constituting a front side part of a vehicle body.

### BACKGROUND

A front side body of a vehicle may be formed by assembling as many as 50 or more parts. To reduce the weight of a vehicle, methods for minimizing parts of the front side body of a vehicle that has been formed by assembling 50 or more parts are being carried.

If weight reduction of the front side body of a vehicle is realized, the robustness of the body may be weakened, there is a need for the front side body of a vehicle that can realize weight reduction and satisfy minimum robustness thereof.

### SUMMARY

According to the present disclosure, a body of a vehicle may comprise a front side member comprising a crash box at a front end of the front side member, wherein the front side member is configured to extend in a longitudinal direction of the vehicle, a shock absorber housing disposed between the front end and a rear end of the front side member and connected to the front side member, and a pillar connected to the rear end of the front side member, wherein the front side member, the shock absorber housing, and the pillar are molded integrally with each other, and first horizontal ribs and first vertical ribs are formed to cross each other at the front end to create spaces, wherein the first horizontal ribs are parallel to the longitudinal direction of the vehicle, and wherein the first vertical ribs are vertical to the longitudinal direction of the vehicle.

The body, wherein the first horizontal ribs and the first vertical ribs are configured to face an outer side of the vehicle.

The body, wherein the first horizontal ribs are configured to locate horizontal sections of a portion of the first horizontal ribs on a same level as horizontal sections of the front side member.

The body, wherein the front end of the front side member comprises a crash box mounting part to which the crash box is configured to be coupled.

The body, wherein the first horizontal ribs and the first vertical ribs are configured to be behind the crash box mounting part.

The body, wherein the front end of the front side member comprises a connection bracket to which a front end portion of a fender apron member is configured to be connected.

The body, wherein the front end portion of the fender apron member is configured to be connected to a first end of the connection bracket, and a second end of the connection bracket is configured to be on a same level as a portion of the first vertical ribs formed at the front end portion of the front side member.

The body, wherein the front end of the front side member comprises a sub-frame mounting part to which a sub-frame is configured to be coupled.

The body, wherein the sub-frame mounting part is configured to be on a same level as a portion of the first vertical ribs formed at the front end of the front side member.

The body, wherein the front end of the front side member comprises a crossbar mounting part to which a crossbar for connecting a pair of front side members is configured to be mounted.

The body, wherein the crossbar mounting part is configured to extend in a transverse direction of the vehicle and is configured to be open at one surface, and a portion of surfaces constituting the crossbar mounting part is configured to be on the same level as a portion of the first horizontal ribs or a portion of the first vertical ribs formed at the front end of the front side member.

The body, wherein one or more selected from a group, may comprise the front side member, the shock absorber housing, and the pillar, comprise second horizontal ribs and second vertical ribs formed to cross each other to create spaces.

The body, wherein the second horizontal ribs are configured to create spaces toward an outside space of the vehicle by extending from the first horizontal ribs.

The body, wherein the spaces created by the second horizontal ribs and the second vertical ribs crossing each other are configured to face an inside space or an outside space of the vehicle.

The body, wherein one or more selected from a group, may comprise the front side member, the shock absorber housing, and the pillar, comprise diagonal ribs, wherein the diagonal ribs are configured to pass through cross points of the second horizontal ribs and the second vertical ribs, to partition the spaces created by the second horizontal ribs and the second vertical ribs.

According to the present disclosure, a vehicle may comprise a front side member comprising a crash box at a front end of the front side member, wherein the front side member is configured to extend in a longitudinal direction of the vehicle, a shock absorber housing disposed between the front end and a rear end of the front side member and connected to the front side member, and a pillar connected to the rear end of the front side member, wherein the front side member, the shock absorber housing, and the pillar are molded integrally with each other, and first horizontal ribs and first vertical ribs are formed to cross each other at the front end to create spaces, and wherein the spaces are configured to be deformed upon receiving a load to the crash box such that crash impact to the vehicle is reduced.

The vehicle, wherein the front side member has a structure of a back beam connected to the crash box so that an object that has collided with a front portion of the vehicle to obliquely pass the vehicle.

The vehicle, wherein an angle of deformation of a back beam connected to the crash box is set so that an object colliding with a front portion of the vehicle is caused to pass the vehicle at an angle that is not perpendicular.

According to the present disclosure, a method for manufacturing a body of a vehicle, the method may comprise forming a front side member comprising a crash box at a front end of the front side member, the front side member extending in a longitudinal direction of the vehicle, disposing a shock absorber housing between the front end and a rear end of the front side member and connecting the shock absorber housing to the front side member, connecting a pillar to the rear end of the front side member, integrally molding the front side member, the shock absorber housing, and the pillar with each other, and creating spaces by forming first horizontal ribs and first vertical ribs to cross each other at the front end, wherein the first horizontal ribs are parallel to the longitudinal direction of the vehicle, and wherein the first vertical ribs are vertical to the longitudinal direction of the vehicle.

The method, further may comprise setting an angle of deformation of a back beam connected to the crash box so that an object colliding with a front portion of the vehicle is caused to pass the vehicle at an angle that is not perpendicular.

### BRIEF DESCRIPTION OF THE DRAWINGS

FIGS. 1 and 2 show examples of a front side body of a vehicle according to an example of the present disclosure.

FIG. 3 shows an example of a front end of a front side member to which a crash box is coupled.

FIG. 4 shows an example of a main load path of the front side body of a vehicle.

FIG. 5 shows an example of the front side member at which a connection bracket is formed.

FIG. 6 shows an example of a sectional view taken along line A-A of FIG. 2.

FIG. 7 shows an example of the front side member at which a crossbar mounting part is formed.

FIG. 8 shows an example of an outer portion of the front side member at which the crossbar mounting part is formed.

FIG. 9 shows an example of an inner side surface of the front side body of a vehicle according to an example of the present disclosure.

### DETAILED DESCRIPTION

Hereafter, an example of the present disclosure will be described in detail with reference to the accompanying drawings and the same or similar components are given the same reference numerals regardless of the numbers of figures and are not repeatedly described.

In the following description, if it is decided that the detailed description of known technologies related to the present disclosure makes the subject matter of the example described herein unclear, the detailed description is omitted. Furthermore, the accompanying drawings are provided only for easy understanding of the example disclosed in the specification, and the technical spirit disclosed in the specification is not limited by the accompanying drawings, and all changes, equivalents, and replacements should be understood as being included in the spirit and scope of the present disclosure.

Terms including ordinal numbers such as “first”, “second”, etc. may be used to describe various components, but the components are not to be construed as being limited to the terms. The terms are used only to distinguish one component from another component.

Singular forms are intended to include plural forms unless the context clearly indicates otherwise.

It will be further understood that the terms “comprise” or “have” used in this specification, specify the presence of stated features, steps, operations, components, parts, or a combination thereof, but do not preclude the presence or addition of one or more other features, numerals, steps, operations, components, parts, or a combination thereof.

The suffixes “module” and “part” for the components used in the following description are given or mixed in consideration of only the ease of writing the specification, and do not have distinct meanings or roles by themselves.

It is to be understood that when one element is referred to as being “connected to” or “coupled to” another element, it may be connected directly to or coupled directly to another element or be connected to or coupled to another element, having the other element intervening therebetween. On the other hand, it should to be understood that when one element is referred to as being “connected directly to” or “coupled directly to” another element, it may be connected to or coupled to another element without the other element intervening therebetween.

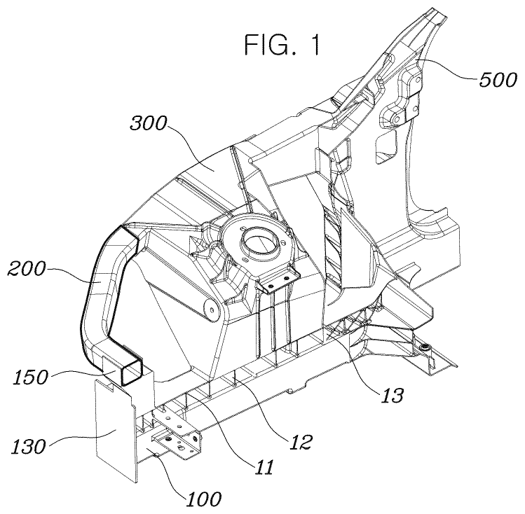

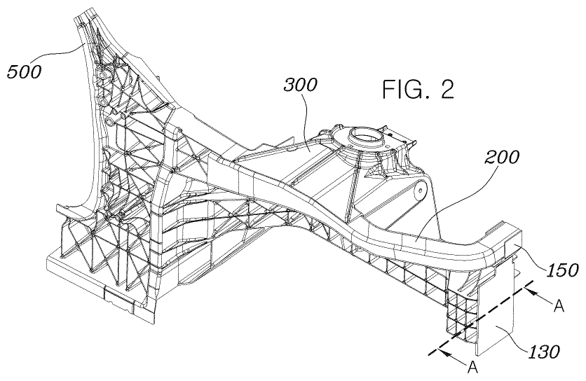

FIGS. 1 and 2 show examples of a front side body of a vehicle according to an example of the present disclosure.

Referring to FIGS. 1 and 2, according to the example of the present disclosure, the front side body of a vehicle includes a front side member 100, a shock absorber housing 300, and an A-pillar 500. Specifically, the front side body of a vehicle is characterized in that the front side member 100, the shock absorber housing 300, and the A-pillar 500 are molded integrally with each other.

More specifically, the front side body of a vehicle is a side structure of a vehicle that extends from the front end of the vehicle to the rear end. The front side body absorbs a load (energy) during a vehicle's forward collision and disperses the load uniformly to the entire vehicle body to protect a passenger from the collision.

The front side body of a vehicle may be produced by various parts welded together as well as the front side member, the shock absorber housing, and the A-pillar. In this process, about 30 to 50 or more parts may be coupled to each other in a welding manner.

In the welding-type manufacturing method of the front side body of a vehicle, many flanges may be formed to couple the parts to each other. The flanges are causes of increasing the weight of the front side body of a vehicle. Furthermore, since numerous parts may be manufactured separately, the time and the amount of work required for manufacturing the parts increase, which is a disadvantage.

In the present disclosure, as a part of the front side body of a vehicle is molded to be integrated, welding between parts may be minimized or reduced and the weight of the front side body of a vehicle is reduced simultaneously so that the above problem may be removed.

Specifically, the front side body of a vehicle is characterized to mold integrally the front side member 100, the shock absorber housing 300, and the A-pillar 500 that occupy large volumes in the front side body.

According to the relevant method, since the front side member 100, the shock absorber housing 300, and the A-pillar 500 which occupy most volume in the front side body of a vehicle are molded integrally with each other, welded surfaces may be minimized or reduced. The front side member 100, shock absorber housing 300, and A-pillar 500 could be integrally molded using polypropylene through injection molding for a lightweight, impact-resistant component, using epoxy resin in compression molding to create a strong, heat-resistant integral part, or using resin transfer molding with carbon fiber reinforced plastic for high strength and reduced weight.

The more welded surfaces the front side body has, the more likely it is that the welded surfaces will break by a load. If a welded surface breaks, it is difficult to transfer the load. If an excessive load is concentrated to a specific portion, another welded surface may break and it is difficult to disperse the load.

However, the relevant method has an advantage of appropriately achieving load transfer and dispersion by minimizing welded surfaces.

In the front side body of a vehicle according to the present disclosure, the left front side body and the right front side body are provided symmetrically or substantially symmetrically each other and are connected to each other by a crossbar, etc. A space between the left front side body and the right front side body may be provided as an engine room or a space equipped with power electronic parts (e.g., inverter, converter, motor controller, power distribution unit, high-voltage wiring and connectors, auxiliary power modules, charging interface, etc.) of an electric vehicle.

An open section may have robustness lower than a closed section. To secure the robustness of the front side body of a vehicle formed in an open section, the front end of the front side member 100 may have first horizontal ribs 21 and first vertical ribs 22. The first horizontal ribs 21 and the first vertical ribs 22 may efficiently disperse stress applied to the vehicle body and partially absorb the stress to increase the robustness of the open section.

Furthermore, the spaces created by the first horizontal ribs 21 and the first vertical ribs 22 may absorb a load generated from a collision while providing a space where the vehicle body may be deformed from the collision. At this point, the first horizontal ribs 21 and the first vertical ribs 22 are formed to face the outer side of the vehicle so that the spaces provided by the first horizontal ribs 21 and the first vertical ribs 22 face the outer side of the vehicle. Alternatively or additionally, spaces may be created by a honeycomb structure, where a hexagonal grid pattern may be used to create the honeycomb structure for more uniform load distribution. Alternatively or additionally, spaces may be created by corrugated or wave-like patterns creating alternating ridges and grooves, by a series of interconnected triangular elements forming a truss structure, by a grid-like lattice structure with crisscrossing elements, by using foam inserts within molded parts, by integrating hollow tubes, or by using panels with a series of holes or perforations, etc.

Meanwhile, in some cases, although a separate bracket is provided to couple a crash box to the front side member, the separate bracket increases the weight and production cost of the front side body of a vehicle, and the relevant bracket may be separated from an impact.

To solve the above problem, he front side body of a vehicle of the present disclosure may have a structure of directly coupling a crash box 600 to a front end of the front side member 100.

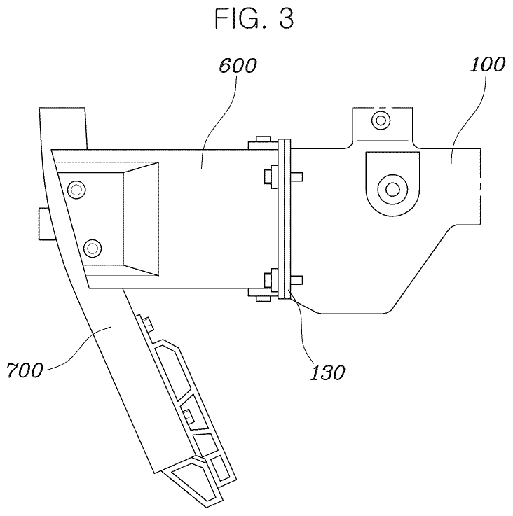

The front end of the front side member 100 may have a crash box mounting part 130 to which the crash box 600 is coupled. FIG. 3 shows an example of a front end of a front side member to which a crash box is coupled. Referring to FIGS. 1 and 3, the crash box 600 may be coupled to the crash box mounting part 130 of the front side member 100 in a welding or bolting manner.

The crash box 600 may be coupled to a back beam of a vehicle. The crash box 600 and the back beam 700 are portions where a load is applied from a vehicle's forward collision. The crash box 600 is manufactured to facilitate deformation if a load is applied, and a direction in which the crash box 600 is deformed may be designed. Therefore, if a load is applied to the crash box 600, an angle of deforming the back beam 700 connected to the crash box 600 and extending in the transverse direction of the vehicle is limited (e.g., a range of 10-20 degrees, a range of 15-25 degrees, a range of 20-30 degrees, a range of 25-35 degrees), so that an object that has collided with the front portion of the vehicle may be induced or caused to obliquely (e.g., at an angle, not straight or perpendicular, indirectly) pass the vehicle.

In addition or alternative, the first horizontal ribs 21 and the first vertical ribs 22 are formed behind the crash box mounting part 130 to which the crash box 600 is coupled, i.e., at the front end of the front side member 100. Multiple spaces created by the first horizontal ribs 21 and the first vertical ribs 22 may support the deformation of the back beam 700 during a vehicle's forward or substantially forward collision.

Meanwhile, a connection bracket 150 connected to a front end portion of a fender apron member 200 may be formed at the front end of the front side member 100. The fender apron member 200 may be provided as a separate part, a first end portion of the fender apron member 200 may be connected to the front end of the front side member 100, and a second end portion of the fender apron member 200 may be connected to the shock absorber housing 300.

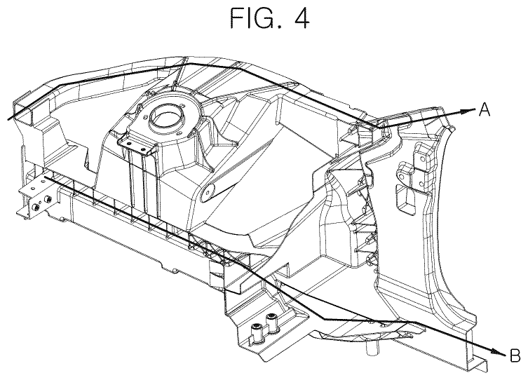

The fender apron member 200 may create a load transfer path during a vehicle's forward or substantially forward collision, as shown in FIG. 4. In other words, a shock applied to the front side member 100 may move to the A-pillar 500 through the fender apron member 200 and the shock absorber housing 300 (A).

In addition or alternative, a shock applied to the front side member 100 may be (e.g., directly or substantially directly) moved to the A-pillar 500 (B) after passing through the front side member 100.

An A-pillar outer is coupled to one end portion of the A-pillar 500, and a side sill may be coupled to another end portion of the A-pillar 500. Therefore, a load transferred to the A-pillar 500 may be moved to the A-pillar and the side sill and may be transferred to a B-pillar and a C-pillar.

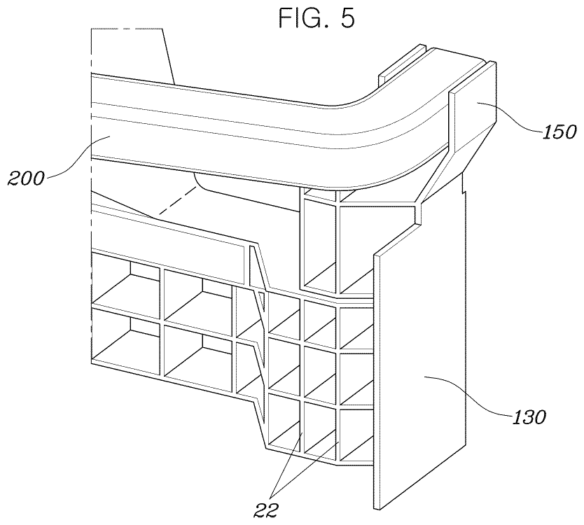

Meanwhile, in order to uniformly transfer a load during a forward collision of a vehicle to the entire vehicle body, a formation location of the first vertical ribs 22 may be regulated. FIG. 5 shows an example of the front side member at which a connection bracket is formed.

Referring to FIG. 5, it is confirmed that the front end portion of the fender apron member 200 is connected to a first end of the connection bracket 150, and a second end of the connection bracket 150 is formed on the same level as some of the first vertical ribs 22 formed at the front end portion of the front side member 100.

The two first vertical ribs 22 and the second end of the connection bracket 150 are located on the same level or substantially the same level, and the second end of the connection bracket 150 and the crash box mounting part 130 extend in a height or a vertical direction of the vehicle to constitute a part of the connection bracket 150.

Some of the first vertical ribs 22 and the second end of the connection bracket 150 are located on the same level or substantially the same level, so a load moved in the height direction of the vehicle during a vehicle's forward substantially forward collision may be transferred to the fender apron member 200 to be dispersed.

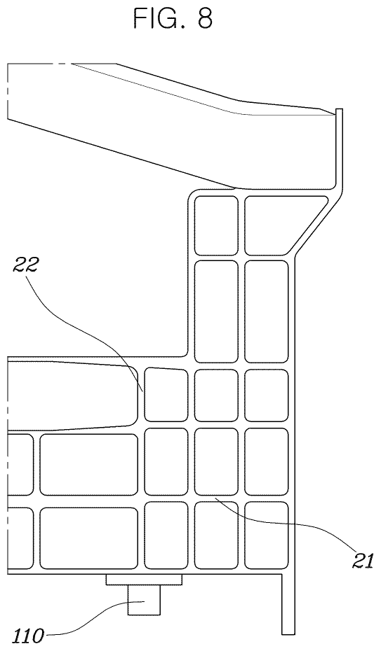

In addition or alternative, referring to FIG. 8, the front end of the front side member 100 may have a sub-frame mounting part 110 to which a sub-frame is coupled. The sub-frame may be coupled to the front side member 100 to support a load of an engine and/or a transmission.

Meanwhile, the sub-frame mounting part 110 formed at the front side member 100 may be formed on the same level or substantially the same level as some of the first vertical ribs 22 formed at the front end portion of the front side member. Accordingly, a load moved in the height or vertical direction of the vehicle along the sub-frame during a forward substantially forward collision of the vehicle may be transferred to the fender apron member 200 so that the load may be dispersed.

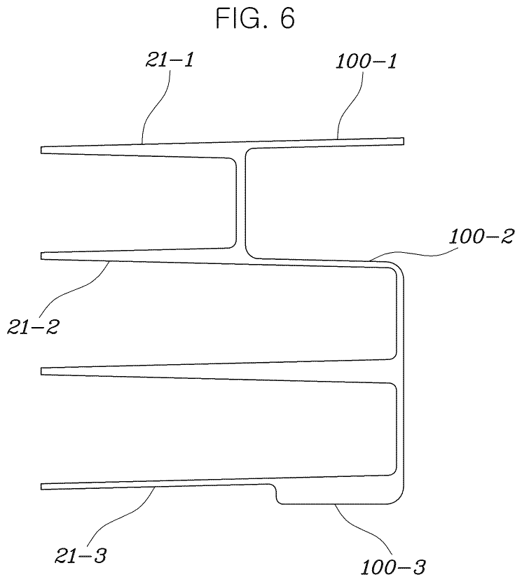

Meanwhile, the first horizontal ribs 21-1, 21-2, and 21-3 may be formed so that horizontal sections 21-1, 21-2, and 21-3 of the first horizontal ribs are located on the same level as horizontal sections 100-1, 100-2, and 100-3 of the front side member. FIG. 6 shows an example of a sectional view taken along line A-A of FIG. 2. Referring to FIG. 6, it is confirmed that the first horizontal ribs 21 is formed so that the horizontal sections 21-1, 21-2, and 21-3 of some of the first horizontal ribs are located on the same level as the horizontal sections 100-1, 100-2, and 100-3 of the front side member.

This is to uniformly disperse a load from a vehicle's forward or substantially forward collision to the vehicle body with the horizontal sections of the front side member 100 and the first horizontal ribs 21 formed at the front end of the front side member 100 that are located at the same levels or at substantially the same levels.

Meanwhile, the front end of the front side member 100 may have a crossbar mounting part 170 to which a crossbar is mounted to connect the pair of front side members 100 to each other. The crossbar mounting part 170 may also be molded integrally with the front side member 100. For example, the crossbar mounting part 170 may molded integrally with the front side member 100 using polypropylene through injection molding for a lightweight, impact-resistant component, using epoxy resin in compression molding to create a strong, heat-resistant integral part, or using resin transfer molding with carbon fiber reinforced plastic for high strength and reduced weight.

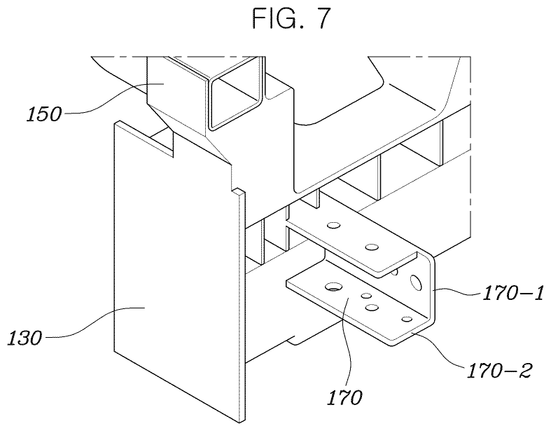

FIG. 7 shows an example of the front side member at which the crossbar mounting part is formed. FIG. 8 shows an example of an outer portion of the front side member at which the crossbar mounting part is formed.

The crossbar mounting part 170 extends in the transverse or substantially transverse direction of the vehicle and has a form with one open or external surface. The crossbar mounting part 170 has three closed or internal surfaces to be stably coupled to the crossbar, and the crossbar mounting part 170 may be coupled to the crossbar while the crossbar is inserted into the one open surface.

Meanwhile, in order to uniformly or substantially uniformly transfer a load from a forward or substantially forward collision of the vehicle to the vehicle body, some surfaces constituting the crossbar mounting part 170 may be formed on the same level or substantially the same level as the first horizontal ribs 21 or the first vertical ribs 22 formed at the front end portion of the front side member 100.

Referring to FIGS. 7 and 8, a vertical surface 170-1 of the crossbar mounting part in FIG. 7 may be formed on the same level or substantially the same level as one of the first vertical ribs 22 in FIG. 8. In addition or alternative, a horizontal surface 170-2 of the crossbar mounting part in FIG. 7 may be formed on the same level or substantially the same level as one of the first horizontal ribs 21 in FIG. 8.

Therefore, a load introduced laterally from the left space or the right space may be dispersed to a right or left front side body, which is the effect.

As described above, if a formation location is limited with consideration for relationship between the first horizontal ribs 21 and the first vertical ribs 22 and other components, a collision load may be uniformly dispersed to the entire vehicle body rather than if the first horizontal ribs and the first vertical ribs are randomly arranged.

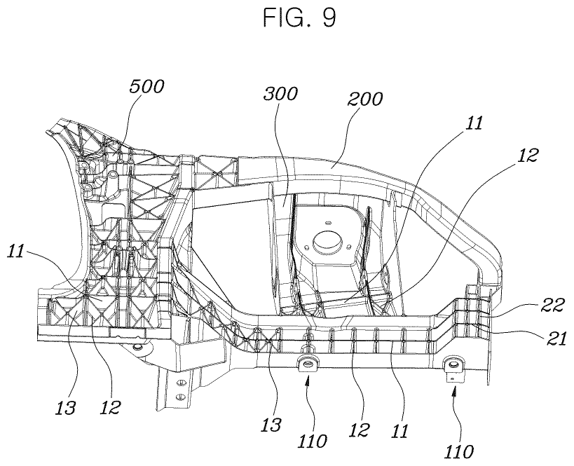

Meanwhile, FIG. 9 shows an example of an inner side surface of the front side body of a vehicle according to an example of the present disclosure. Referring to FIG. 9, one or more selected from a group comprising the front side member 100, the shock absorber housing 300, and the A-pillar molded integrally with each other 500 have second horizontal ribs 11 and second vertical ribs 12 crossing each other to create spaces.

In addition or alternative, referring to FIG. 1, it may be confirmed that the second horizontal ribs 11 and the second vertical ribs 12 are formed at multiple points of the front side member 100 to face the inside space of the vehicle.

Specifically, referring to FIG. 9, in the front side member 100 of the front side body of a vehicle that is molded integrally, the multiple second horizontal ribs 11 and the multiple second vertical ribs 12 are formed to cross each other to create spaces. Each of the second horizontal ribs 11 is formed by extending from each of the first horizontal ribs 21, and each of the second horizontal ribs 11 crosses each of the second vertical ribs 12 to create a space toward the outside space of the vehicle. Alternatively or additionally, spaces may be created by a honeycomb structure, where a hexagonal grid pattern may be used to create the honeycomb structure for more uniform load distribution. Alternatively or additionally, spaces may be created by corrugated or wave-like patterns creating alternating ridges and grooves, by a series of interconnected triangular elements forming a truss structure, by a grid-like lattice structure with crisscrossing elements, by using foam inserts within molded parts, by integrating hollow tubes, or by using panels with a series of holes or perforations, etc.

If a forward collision occurs, a portion where a load is applied first may be the front end of the front side member 100. Therefore, the front end of the front side member 100 may appropriately transfer and disperse a load while being sufficiently deformed.

To this end, the first horizontal ribs 21 and the first vertical ribs 22 are formed to cross each other from the front end of the front side member 100. A load transferred from the crash box mounting part 130 may be transferred to the second horizontal ribs 11 through the first horizontal ribs 21, and the spaces created by the multiple ribs may enable the front side member 100 to be sufficiently deformed by the load from a vehicle's forward collision.

On the other hand, sufficient spaces may be provided for deforming the front side member 100 by a load. The front side member 100 may be sufficiently deformed through the spaces created by the first horizontal ribs 21 and the first vertical ribs 22 and the spaces created by the second horizontal ribs 11 and the second vertical ribs 12, and the load may be efficiently transferred to the A-pillar 500 with sufficient deformation.

Meanwhile, diagonal ribs 13 may be formed in one or more selected from a group comprising the front side member 100, the shock absorber housing 300, and the A-pillar 500, and the diagonal ribs 13 pass through cross points of the second horizontal ribs 11 and the second vertical ribs 12.

Because of the provision of the diagonal ribs 13, the spaces created by the second horizontal ribs 11 and the second vertical ribs 12 may be partitioned to increase the sectional areas of the vehicle body, and the front side body of a vehicle may secure greater robustness.

Because of the provision of the diagonal ribs 13, the front side body of a vehicle obtains additional robustness, thereby reducing the degree of deformation caused by a load. The sufficient deformation of the front side body of a vehicle is to transfer and disperse a load, but continuous deformation of the vehicle body may cause physical injury to the passenger. Specifically, in case of a vehicle body located close to a passenger, the degree of deformation may be reduced to protect a passenger from a forward collision.

In other words, the front end of the front side member 100 located relatively far from the passenger may enable the vehicle body to be sufficiently deformed while having the second horizontal ribs 11 and the second vertical ribs 12, so a load may be efficiently transferred to the A-pillar 500 and be dispersed. At this point, the front end of the front side member 100 may include parts from the foremost end of the front side member 100 to a portion where the shock absorber housing may be disposed.

On the other hand, since a portion behind a portion, where the shock absorber housing 300 of the front side member 100 is arranged, is a portion where the front side body of a vehicle is located relatively close to the passenger, the passenger may be protected from deformation of the vehicle body by further reducing the degree of deformation of the vehicle body.

Therefore, the diagonal ribs 13 may be formed in the rear end of the front side member 100 relatively close to the passenger to secure additional robustness and reduce the degree of deformation of the vehicle body lower than the front end of the front side member 100 to prevent the passenger from injury by vehicle body deformation.

Not only the front side member 100 but also the A-pillar 500 may have additional diagonal ribs 13 to prevent the passenger from injury by vehicle body deformation.

The present disclosure is proposed to provide a front side body of a vehicle, the front side body being capable of simultaneously reducing weight and protecting a passenger during a forward collision of a vehicle.

Specifically, the present disclosure is proposed to provide a front side body of a vehicle, the front side being capable of corresponding a small overlap collision by having first horizontal ribs and first vertical ribs formed in a front side member of the front side body of a vehicle.

According to an example of the present disclosure, there is provided a front side body of a vehicle, the front side body including: a front side member extending in a longitudinal direction of a vehicle (e.g., a driving direction of a vehicle), and including a crash box at a front end; a shock absorber housing disposed between front and rear ends of the front side member and connected to the front side member; and an A-pillar connected to the rear end of the front side member, wherein the front side member, the shock absorber housing, and the A-pillar may be molded integrally with each other, and first horizontal ribs and first vertical ribs may be formed to cross each other at a front end portion of the front side member to create spaces.

The first horizontal ribs and the first vertical ribs may be formed to face an outer side of the vehicle.

The first horizontal ribs may be formed to locate horizontal sections of a portion of the first horizontal ribs on the same level as horizontal sections of the front side member.

The front end of the front side member may include a crash box mounting part to which the crash box is coupled.

The first horizontal ribs and the first vertical ribs may be formed behind the crash box mounting part.

The front end of the front side member may include a connection bracket to which a front end portion of a fender apron member is connected.

The front end portion of the fender apron member may be connected to a first end of the connection bracket, and a second end of the connection bracket may be formed on the same level as a portion of the first vertical ribs formed at the front end portion of the front side member.

The front end of the front side member may include a sub-frame mounting part to which a sub-frame is coupled.

The sub-frame mounting part may be formed on the same level as a portion of the first vertical ribs formed at the front end portion of the front side member.

The front end of the front side member may include a crossbar mounting part to which a crossbar for connecting a pair of front side members is mounted.

The crossbar mounting part may extend in a transverse direction of the vehicle and be open at one surface, and a portion of surfaces constituting the crossbar mounting part may be formed on the same level as a portion of the first horizontal ribs or a portion of the first vertical ribs formed at the front end portion of the front side member.

One or more selected from a group comprising the front side member, the shock absorber housing, and the A-pillar that are molded integrally with each other may include second horizontal ribs and second vertical ribs formed to cross each other to create spaces.

The second horizontal ribs creating spaces toward an outside space of the vehicle may be formed by extending from the first horizontal ribs.

The spaces created by the second horizontal ribs and the second vertical ribs crossing each other may be arranged to face an inside space or an outside space of the vehicle.

One or more selected from a group comprising the front side member, the shock absorber housing, and the A-pillar may include diagonal ribs, the diagonal ribs passing through cross points of the second horizontal ribs and the second vertical ribs, to partition the spaces created by the second horizontal ribs and the second vertical ribs.

According to the present disclosure, the front side member, the shock absorber housing, and the A-pillar are molded integrally with each other, so that the weight reduction front side body of a vehicle may be provided.

The crash box mounting part is directly formed at the front end of the front side member, and the first horizontal ribs and the first vertical ribs are formed at the front end of the front side member so that the vehicle can correspond to an impact from a small overlap collision.

One or more selected from a group comprising the front side member, the shock absorber housing, and the A-pillar have the horizontal ribs and the vertical ribs formed to cross each other to form spaces, thereby inducing sufficient deformation of a vehicle body during a forward collision of the vehicle. Some of the points where the horizontal ribs and the vertical ribs cross each other have the diagonal ribs to increase robustness further to reduce the degree of deformation, thereby protecting a passenger from an external impact.

Although the present disclosure was provided above about specific examples shown in the drawings, it is apparent to those skilled in the art that the present disclosure may be changed and modified in various ways without departing from the scope of the present disclosure, which is provided in the following claims.

What is claimed is:

1. A body of a vehicle comprising:
a front side member comprising a crash box at a front end of the front side member, wherein the front side member is configured to extend in a longitudinal direction of the vehicle;
a shock absorber housing disposed between the front end and a rear end of the front side member and connected to the front side member; and
a pillar connected to the rear end of the front side member,
wherein the front side member, the shock absorber housing, and the pillar are molded integrally with each other, and first horizontal ribs and first vertical ribs are formed to cross each other at the front end to create spaces, wherein the first horizontal ribs are parallel to the longitudinal direction of the vehicle, and wherein the first vertical ribs are vertical to the longitudinal direction of the vehicle.

2. The body of claim 1, wherein the first horizontal ribs and the first vertical ribs are configured to face an outer side of the vehicle.

3. The body of claim 2, wherein the first horizontal ribs are configured to locate horizontal sections of a portion of the first horizontal ribs on a same level as horizontal sections of the front side member.

4. The body of claim 1, wherein the front end of the front side member comprises a crash box mounting part to which the crash box is configured to be coupled.

5. The body of claim 4, wherein the first horizontal ribs and the first vertical ribs are configured to be behind the crash box mounting part.

6. The body of claim 1, wherein the front end of the front side member comprises a connection bracket to which a front end portion of a fender apron member is configured to be connected.

7. The body of claim 6, wherein the front end portion of the fender apron member is configured to be connected to a first end of the connection bracket, and a second end of the connection bracket is configured to be on a same level as a portion of the first vertical ribs formed at the front end portion of the front side member.

8. The body of claim 1, wherein the front end of the front side member comprises a sub-frame mounting part to which a sub-frame is configured to be coupled.

9. The body of claim 8, wherein the sub-frame mounting part is configured to be on a same level as a portion of the first vertical ribs formed at the front end of the front side member.

10. The body of claim 1, wherein the front end of the front side member comprises a crossbar mounting part to which a crossbar for connecting a pair of front side members is configured to be mounted.

11. The body of claim 10, wherein the crossbar mounting part is configured to extend in a transverse direction of the vehicle and is configured to be open at one surface, and a portion of surfaces constituting the crossbar mounting part is configured to be on a same level as a portion of the first horizontal ribs or a portion of the first vertical ribs formed at the front end of the front side member.

12. The body of claim 1, wherein one or more selected from a group, comprising the front side member, the shock absorber housing, and the pillar, comprise second horizontal ribs and second vertical ribs formed to cross each other to create spaces.

13. The body of claim 12, wherein the second horizontal ribs are configured to create spaces toward an outside space of the vehicle by extending from the first horizontal ribs.

14. The body of claim 12, wherein the spaces created by the second horizontal ribs and the second vertical ribs crossing each other are configured to face an inside space or an outside space of the vehicle.

15. The body of claim 12, wherein one or more selected from a group, comprising the front side member, the shock absorber housing, and the pillar, comprise diagonal ribs, wherein the diagonal ribs are configured to pass through cross points of the second horizontal ribs and the second vertical ribs, to partition the spaces created by the second horizontal ribs and the second vertical ribs.

16. A vehicle comprising:
a front side member comprising a crash box at a front end of the front side member, wherein the front side member is configured to extend in a longitudinal direction of the vehicle;
a shock absorber housing disposed between the front end and a rear end of the front side member and connected to the front side member; and
a pillar connected to the rear end of the front side member,
wherein the front side member, the shock absorber housing, and the pillar are molded integrally with each other, and first horizontal ribs and first vertical ribs are formed to cross each other at the front end to create spaces; and
wherein the spaces are configured to be deformed upon receiving a load to the crash box such that crash impact to the vehicle is reduced.

17. The vehicle of claim 16, wherein:
The front side member has a structure of a back beam connected to the crash box so that an object that has collided with a front portion of the vehicle to obliquely pass the vehicle.

18. The vehicle of claim 16, wherein:
an angle of deformation of a back beam connected to the crash box is set so that an object colliding with a front portion of the vehicle is caused to pass the vehicle at an angle that is not perpendicular.

19. A method for manufacturing a body of a vehicle, the method comprising:
forming a front side member comprising a crash box at a front end of the front side member, the front side member extending in a longitudinal direction of the vehicle;
disposing a shock absorber housing between the front end and a rear end of the front side member and connecting the shock absorber housing to the front side member;
connecting a pillar to the rear end of the front side member;
integrally molding the front side member, the shock absorber housing, and the pillar with each other; and
creating spaces by forming first horizontal ribs and first vertical ribs to cross each other at the front end, wherein the first horizontal ribs are parallel to the longitudinal direction of the vehicle, and wherein the first vertical ribs are vertical to the the longitudinal direction of the vehicle.

20. The method of claim 19, further comprising:
setting an angle of deformation of a back beam connected to the crash box so that an object colliding with a front portion of the vehicle is caused to pass the vehicle at an angle that is not perpendicular.
